(19) United States
(12) Patent Application Publication
(10) Pub. No.: US 2009/0211768 A1
(43) Pub. Date: Aug. 27, 2009

(54) SYSTEM AND METHOD FOR DEPLOYING OPTICAL FIBER IN A WELL

(75) Inventor: Agop Cherbettchian, Santa Monica, CA (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: SABEUS, INC., Calabasas, CA (US)

(21) Appl. No.: 11/815,813

(22) PCT Filed: Jan. 24, 2006
(86) PCT No.: PCT/US06/02549

§ 371 Date: Nov. 10, 2008

Related U.S. Application Data
(60) Provisional application No. 60/646,891, filed on Jan. 25, 2005.

(51) Int. Cl. G02B 6/54; E21B 19/08; B65H 51/10; E21B 19/00

(52) U.S. Cl. 166/385; 166/77.1; 254/134.3 R

(57) ABSTRACT

A system and method for deploying an optical fiber within the bore or a well using a linear traction to push the optical fiber, typically encased in a protective sheath, down an instrumentation tube to place an optical fiber sensor at a desired location with the bore of the well.

### CROSS-REFERENCE TO RELATED APPLICATION

This application claims the benefit of priority to U.S. Provisional Application No. 60/646,891, filed Jan. 25, 2005, the subject matter of which is incorporated in its entirety.

### BACKGROUND OF THE INVENTION

This invention relates generally to an improved method for deploying fiber optic cable and fiber optic sensors into hostile environments such as down well bores.

Fiber optic sensors are beginning to be used in oil and gas fields to sense parameters of interest to operators such as temperature and pressure down well bores. The primary advantages of fiber optic sensors include the complete elimination of electronics from the well bore as well as the sensors small size and weight. The optical fiber itself serves as both the sensor and the telemetry path. Since the optical fiber itself is hair-thin and therefore relatively delicate, special care must be taken to protect it as it is being placed in the well bore and during normal operation of the well. One such method that has been seeing widespread use is to install a small hollow metal tube, sometimes referred to as a capillary tube or instrumentation tube, having an outside diameter of approximately ¼ inch down the well as it is being completed. Such tubes are also typically installed in well bores for other purposes, such as chemical injection.

Frequently, when the purpose of deployment is for testing, an electrical conductor is also installed to operate a testing device or apparatus. In many instances, the optical fiber cable is deployed in the capillary tube that has already been installed in the well. A fiber optic cable is basically comprised of a glass or plastic fiber core, one or more buffer layers, and a protective sheath. The optical fiber is typically a single optical fiber strand, coated with a thin layer of a protective material. The protective sheath is typically composed of a heat polymerized organic resin and may be impregnated with reinforcing fibers. A typical fiber optic is not sufficiently robust for installation in well bores where the operating temperatures may reach 250° C. In addition, the fiber optic cable frequently must be installed at lengths of up to 40,000 feet. State-of-the-art apparatus for installing such fiber optic cable typically include means for pulling the cable from a cable reel, propelling the cable by means of tractor gears, or a capstan, and in some cases, impelling the cable through the duct by means of fluid drag. All of the state-of-the-art methods for installing the cable place various stresses on the fiber optic core, causing degradation in the performance of the cable, and reducing the ability of the cable to resist conditions in which the cable may be installed.

Following completion of the well, an optical sensing fiber is installed inside the instrumentation or capillary tubing. Existing systems for installing optical fiber-based sensors in a well use fluids at high pressure to pull a fiber (or fiber enclosed in a protective sheath) down pre-installed tubing. The fluid flowing inside the tubing pulls the fiber along with it via fluid drag. If the fiber is enclosed inside a protective sheath, a pig may be attached to the distal end of the sheath to increase the pulling force. One advantage of this approach is the ability to replace a failed optical fiber, i.e., by pumping it out and re-pumping in a new one without interrupting the normal operation of the well. Such an interruption of well operation is commonly called an intervention, and is typically expensive, therefore to be avoided if possible.

There are several disadvantages associated with the current method of fiber deployment. First, the fluids used to pump the fiber down the instrumentation or capillary tube may be harmful to the optical fiber and lead to failure of the optical fiber over time, especially at the elevated temperatures typically seen within a well bore. Although various fluids have been provided that minimize degradation of the optical fiber, it is believed that all of the presently available pumping fluids will degrade the fiber over time to the extent that the optical fiber is eventually rendered unusable and requires replacement. Although pumping the fiber out of the well, and deploying a new fiber is possible, as described above, the procedure is time consuming and expensive even though the well continues to operate during the removal and re-deployment of the fiber.

Another disadvantage with the current method is that it requires high pressure pumps, a source of fluid, and is quite messy due to the leakage of high pressure fluid around the fiber seal area. In addition, the pulling force generated on the fiber via the fluid is quite limited.

It is well known that any moisture (water) present in the instrumentation or capillary tube will also seriously attack the integrity of the optical fiber at elevated temperatures. In addition, hydrogen gas, normally found in many oil and gas wells, tends to seep into the instrumentation or capillary tubing over time. The hydrogen gas is absorbed by the optical fiber, causing the fiber to darken at the high temperatures typically found down a well bore, reducing the amount of light transmitted by the fiber, and degrading the performance of the fiber as a sensor.

The end result of the above described processes is that the optical fiber fails regularly when subjected to high temperatures within the well bore, sometimes in a matter of days, and has to be replaced. Although replacement of the fiber does not require an intervention, the fiber costs tens of thousands of dollars, and special equipment, personnel, and the like have to be brought to the well site, which may be located in an isolated area, to remove the damaged fiber and deploy a new fiber.

What has been needed, and heretofore unavailable, is a system and method for deploying an optical fiber and optical fiber sensor down a well bore that does not require the use of fluid under high pressure to pump the optical fiber and optical fiber sensor down the well bore. The present invention fills these and other needs.

### SUMMARY OF THE INVENTION

In a general aspect, the system and method of the present invention is embodied in a system a system for installing an optical fiber in a well bore, comprising a linear traction engine that grips an optical fiber encased in a micro-tube or other protective sheath and pushes the encased optical fiber down an instrumentation tube mounted within the bore of an oil or gas well. Such a system and method eliminates the potential for damage to the optical fiber that may occur if the encased optical fiber is pumped down the instrumentation tube using a fluid under high pressure.

In another, more detailed aspect, the present invention includes a flexible drive means rotatably mounted around a pair of sprockets, at least one of which is driven by a motor, a pair of opposing walls located on either side of the flexible drive means, each of the pair of opposing walls having a proximal end and a distal end, the proximal end having a ramped portion, and a plurality of gripping assemblies mounted on the flexible drive means, each gripping assembly having a moveable gripping arm having a first end operatively connected to a roller and a second end configured to grip an optical fiber, the gripping assemblies being mounted on the flexible drive belt in pairs such that the roller of each gripping assembly of a pair of gripping assemblies is oriented outward so as to engage the ramped portion of one of the opposing walls as the flexible drive means rotates around the sprockets to depress the roller and moving the gripper arm so that the second end of the gripper arm engages the optical fiber.

In other aspects, the flexible drive means is a chain or may be a belt. In yet another aspect, the present invention may include an adjustable torque limiter disposed between the motor and the driven sprocket to control the force applied to the encased optical fiber. In yet another aspect, buckling of the encased optical fiber may be prevented by limiting an unsupported length of encased optical fiber within the linear traction engine to approximately ten times the outside diameter of the encased optical fiber or less.

In a still further aspect, the moveable gripping arm is biased in an open position, and in another aspect, the moveable gripping arm is biased by a spring. In yet another aspect, the present invention includes a rubber pad disposed on the second end of the moveable gripper arm. In still another aspect, the sheath the optical fiber is encased in is a micro-tube, and in a still further aspect, a spherical shaped plug is disposed on a distal end of the micro-tube. In still another aspect, the micro-tube is wrapped around a spool before coming into engagement with the gripping assemblies, and further comprising a set of rollers for straightening the micro-tube as it is pulled from the spool before engagement with the gripping assemblies.

In anther aspect, the present invention includes a linear traction engine for imparting motion to a metal micro-tube without imparting different velocity between the micro-tube and clamping components of the engine, comprising a flexible drive means rotatably mounted around a first sprocket and a second sprocket, at least one of which is driven by a motor, a pair of opposing walls located on either side of the flexible drive means, each of the pair of opposing walls having a proximal end and a distal end, the proximal end having a ramped portion, and a plurality of gripping assemblies mounted on the flexible drive means, each gripping assembly having a moveable gripping arm having a first end operatively connected to a roller and a second end configured to grip an optical fiber, the gripping assemblies being mounted on the flexible drive belt in pairs such that the roller of each gripping assembly of a pair of gripping assemblies is oriented outward so as to engage the ramped portion at the proximal end of one of the opposing walls as the flexible drive means rotates around the sprockets to depress the roller and moving the gripper arm so that the second end of the gripper arm engages the optical fiber when the gripping assembly is moving in a linear direction, the engagement with the optical fiber being maintained as the gripping assemblies move along the opposing walls until the gripping assembly reaches a ramp located at the end of the opposing wall, the distal ramp located such that the gripping arm of the gripping assembly disengages from the optical fiber before the movement of the gripping assembly is deflected from the linear direction by the second sprocket.

In still another aspect, the present invention includes a method for installing an optical fiber encased in a protective sheath into a well bore, comprising mounting an optical fiber encased in a protective sheath in a linear traction engine, guiding a distal end of the optical fiber encased in the protective sheath within a proximal opening of an instrument tube, and pushing the optical fiber encased in the protective sheath into the instrument tube using the linear traction engine. In a further aspect, the invention includes disposing a plug on the distal end of the optical fiber encased in the protective sheath to prevent the distal end of the optical fiber encased in the protective sheath from damage caused by internal obstructions in the instrumentation tube.

In still another aspect, the method of the present invention includes gripping and releasing the optical fiber encased in the protective sheath with a gripping assembly so that no differential velocity is imparted between the optical fiber encased in the protective sheath and the linear traction engine, and moving the gripping assembly in a linear direction to push the optical fiber encased in the protective sheath into the instrumentation tube. In another aspect, mounting the optical fiber encased in the protective sheath into the linear traction engine includes straightening the optical fiber encased in the protective sheath before it is mounted in the linear traction engine. In still another aspect, pushing includes controlling applying a pushing force to the optical fiber encased in the protective sheath such that the applied pushing force does not exceed a safety margin determined from a compressive limit of the sheath.

Other features and advantages of the present invention will become apparent from the following detailed description, taken in conjunction with the accompanying drawings, which illustrate, by way of example, the principles of the present invention.

### BRIEF DESCRIPTION OF THE DRAWINGS

FIG. 1 is a cross-sectional view of an oil and/or gas well, illustrating the location of various structural components thereof, including the location of an instrumentation tubing;

FIG. 2 is a graphical representation, partially in cross-section, illustrating the deployment of an optical fiber into a well by pumping the tubing down the instrumentation tubing;

FIG. 3 is a cross-sectional view of an optical fiber encased in a protective tubing;

FIG. 4 is a front view illustrating an embodiment of the present invention showing a system for pushing an optical fiber down the instrumentation tubing of FIG. 1;

FIG. 5 is a side view of the system of FIG. 2.

### DETAILED DESCRIPTION OF THE PREFERRED EMBODIMENTS

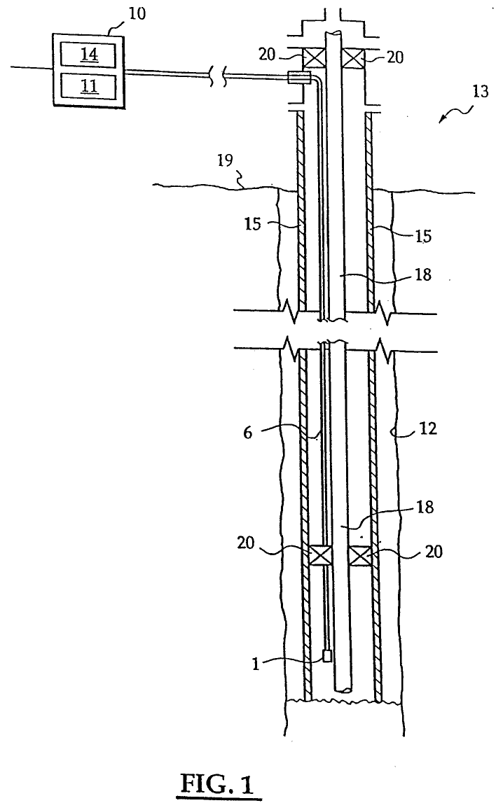

Referring now to the drawings in detail, in which like reference numerals indicate like or corresponding elements among the several figures, there is shown in FIG. 1 a typical well bore having an instrumentation tubing placed therein is depicted. A pressure sensor may be located at the distal end 1 of instrumentation or capillary tubing 6, which is positioned within a well bore 12 of an oil and/or gas well 13. The pressure sensing device may be interconnected via appropriate optical fibers, couplers, and the like, to optical signal processing equipment 10, which is located above the surface of the well bore 12. Well bore 12 may also include casing strings 15 for reinforcing the well bore 12, production tubing 18 for pumping or releasing oil and/or gas from the well 13 and production packers 20.

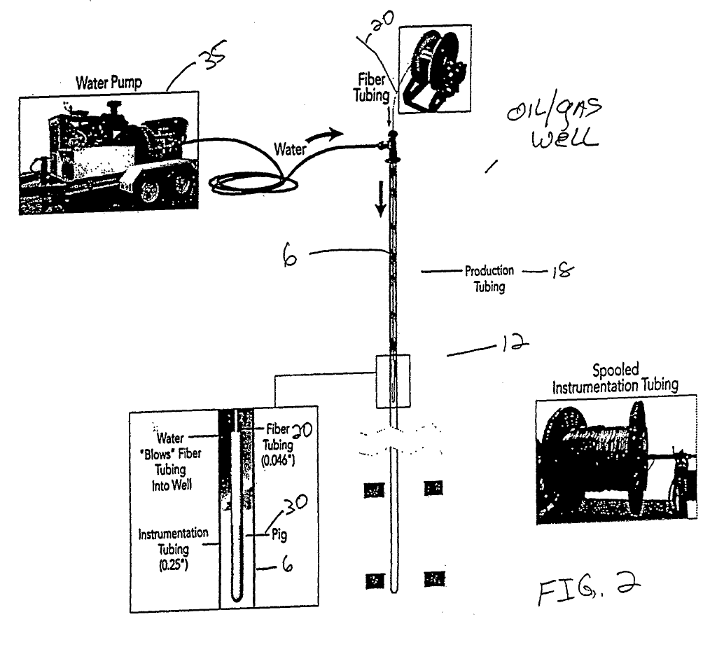

FIG. 2 depicts the method typically used to deploy an optical fiber down a well bore. An optical fiber is inserted through a fitting designed to allow the instrumentation tubing 6 to be pressurized. A high pressure water pump 35 is also operably connected to the instrumentation tubing 6. High pressure water or other appropriate fluid such as one of a number of common silicone oils is pumped down the instrumentation tubing 6. As the high pressure fluid flows down the instrumentation tubing 6, the optical fiber is dragged along with the high pressure water towards the distal, or down hole, end of the instrumentation tubing 6. Pressurized water dragging or installing fiber optic cable presents an opportunity for moisture to enter the fiber optic cable assembly and degrade the optical fibers therein.

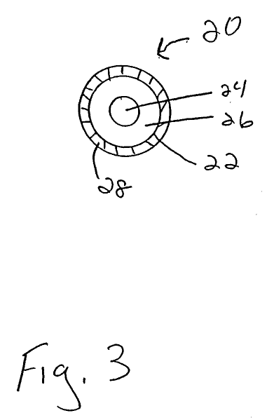

As it is well established in the art, and illustrated in FIG. 3, a common optical fiber consists of three parts: the core, the cladding, and the coating or buffer. Optical fiber tubing 20 includes an optical fiber 22 having a core 24 and cladding 26 encased in a thin tube 28 or coating 32 which provides protection to the optical fiber when it is deployed within the well bore 12 (FIGS. 1-2). The core is the light-guiding central portion of the optical fiber, composed of a material transparent to the wavelength of light being guided. The cladding is the material that surrounds the core of an optical fiber, having a lower index of refraction compared to that of the core. The material surrounding the cladding is typically a soft plastic material that protects the fiber from damage.

In some cases, however, a robust material may be applied to the fiber surrounding the cladding for providing a barrier to protect the fiber optic cable from the harsh environment and corrosive substances of the well bore. For example, the optical fiber may be encased within a thin tubing that is flexible enough so that the optical tubing assembly 20 may be wound and stored on a spool. For example, an optical fiber may be threaded into a length of tubing having a diameter in the range of 0.046 inch and a wall thickness of between 0.005 inch and 0.006 inch. Since the final assembly of the fiber tubing 20 has a diameter of approximately 0.046 inch, it will easily fit within instrumentation tubing 6, which typically has an inner diameter of 0.190 inch. Tubing 28 may be made from stainless or nickel steels, or other materials that prevent the transmission of water vapor or gas from the well into the fiber, and which are flexible enough in the appropriate cross sections to allow the final fiber tubing assembly to be spooled and deployed down instrumentation tubing 6 using currently available equipment.

Preferably, the thin tubing 28 that encases the optical fiber 22 is made of a non-corrosive material. The harsh environment of the well bore, including high temperature oil and/or gas, may accelerate the onset of corrosive effects on the tubing material, thus making the optical fiber susceptible to degradation. Alternative tubing materials may include corrosion resistant metal alloys such as, for example, high nickel content iron compounds and like materials that provide protection from corrosion, especially in harsh environments.

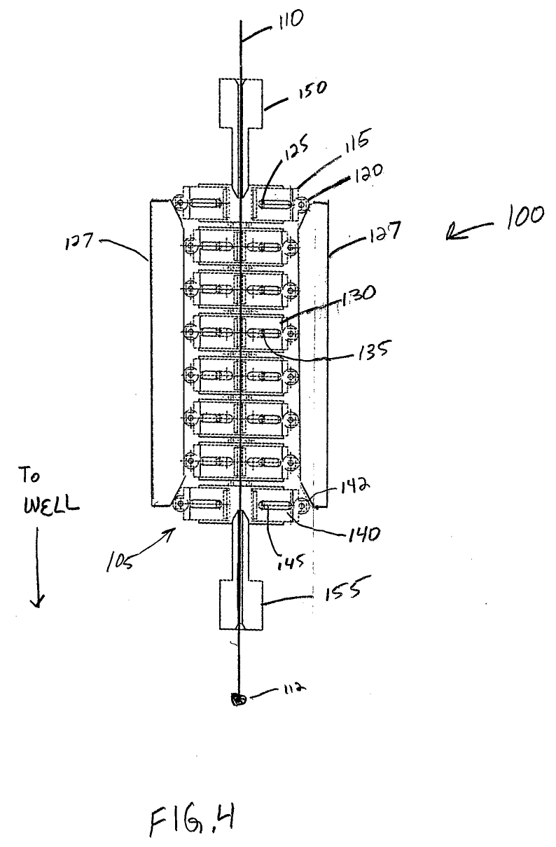

FIG. 4 is a frontal view of an embodiment of a system in accordance with principles of the present invention that avoids the problems inherent in pumping an optical fiber down a well by pushing the optical fiber down the well instead. In this embodiment, a linear traction engine 100 is used to controllably push an armored optical fiber down an instrumentation tube to place a fiber optic sensor deep within an oil or gas well. As will be described, the linear traction engine of the present invention includes various features to prevent slippage of the optical fiber, minimize wear on the gripping surfaces of the traction engine, and prevent damage to the optical fiber.

The linear traction engine 100 utilizes a motor driven belt on which are mounted a number of grippers 115, 130, 140 which are used to controllably grip and release optical fiber 110 while pushing the optical fiber into a well. Grippers 115 are arranged in opposing pairs to allow the optical fiber to be gripped. Each gripper includes a roller wheel 120 and a moveable gripping aim 125. The gripping arm is biases by a spring or other biasing mechanism in a open position, as illustrated by the position of gripping aim 125.

As the belt holding the grippers is driven in a direction causing the optical fiber to be pushed into the well, roller wheel 120 encounters a beveled positioner 127. As the wheel 120 rides up a sloped portion of the positioner 127, the wheel is forced inward, pushing the gripper arm 125 inward to engage the optical fiber. As the linear traction engine continues to drive the optical fiber, the gripper arms fully engage the optical fiber, as indicated by gripper arm 135 of gripper 130. The extent of inward movement of the gripper arm 125 can be adjusted to adjust the amount of pressure exerted on the optical fiber, ensuring that enough pressure can be placed upon the optical fiber to ensure against slippage, but without damaging the optical fiber. Additionally, as is apparent from FIG. 4, the optical fiber is gripped by more than one set of gripping arms, further ensuring against slippage.

As the optical fiber is pushed further down the well, eventually the gripper reaches the distal end of the traction engine. When this occurs, wheel 142 of gripper 140 encounters a second ramped portion of positioner 127, and driven by the bias mechanism of gripper 140, rides the ramped portion outward, allowing gripping arm 145 to disengage from optical fiber 110.

The present invention includes a number of additional features to provide for smooth deployment of an optical fiber down a well bore. For example, traction engine 100 may also include alignment nozzles 150 and 155 to guide the optical fiber encased in protective tubing as it is unspooled and to direct it down the well bore. Additionally, a series of guide wheels (not shown) may also be included to assist in unspooling the armored optical fiber. A small spherical end plug 112 may also be attached to the end of micro-tube encasing the optical fiber to prevent the end of the tube from being damaged should the micro-tube encounter an obstruction on the insider diameter of the instrumentation tube during installation of the optical fiber down the well bore.

In one embodiment, gripper arms 125, 135 and 140 may be spring loaded clamps. The spring loaded claims have rubber pads for gripping the micro-tube encased optical fiber. Such an arrange is advantageous given its ruggedness and simplicity.

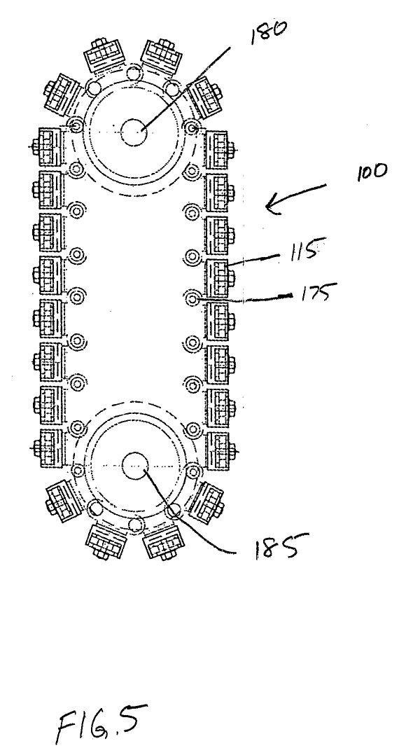

FIG. 5 is a side view of one embodiment of the linear traction engine 100 of the present invention. Grippers 115 are shown mounted on a flexible belt or chain 175. The belt or chain 175 is supported between a drive sprocket 180 and an idler sprocket 185. Referring again to FIG. 4, as the chain exits the drive sprocket, it encounters the beveled portion of position 127 that forces the gripping anus of the grippers 115 together to grip the micro-tube encased optical fiber. The gripper arms are held together until just before the chain or belt 175 reaches the idler sprocket 185, where they are released. In this manner, the gripping action is limited to the linear portion of the belt or chain's motion, thus preventing any differential velocity between the gripping arms and the micro-tube encased optical fiber, which is a major source of wear.

One embodiment of the present invention utilizes a drive motor with an adjustable torque limiter. This allows the pushing force on the micro-tube encased optical fiber to be optimized, while allowing an adequate safety margin based upon the compressive strength of the micro-tube. Using such an embodiment, large pushing forces can be used, approaching the compressive limit of the micro-tubing. Buckling of the micro-tubing can be prevented by limiting the unsupported length of micro-tubing within the traction engine, as well as between the engine and the instrumentation tubing opening, to approximately ten times the outside diameter of the micro-tubing used to encase the optical fiber.

While various embodiments of the present invention have been described with reference to pushing an optical fiber into a well bore, it will be understood that the embodiments of the present invention may also be utilized to pull the micro-tube encased optical fiber out of the instrumentation tube, should such be necessary to repair or replace the optical fiber.

While several particular forms of the invention have been illustrated and described, it will be apparent that various modifications can be made without departing from the spirit and scope of the invention. Accordingly, it is not intended that the scope of the claims be limited except as according to the appended claims.

We claim:

1. A system for installing an optical fiber in a well bore, comprising:
a flexible drive means rotatably mounted around a pair of sprockets, at least one of which is driven by a motor;
a pair of opposing walls located on either side of the flexible drive means, each of the pair of opposing walls having a proximal end and a distal end, the proximal end having a ramped portion; and
a plurality of gripping assemblies mounted on the flexible drive means, each gripping assembly having a moveable gripping arm having a first end operatively connected to a roller and a second end configured to grip an optical fiber, the gripping assemblies being mounted on the flexible drive belt in pairs such that the roller of each gripping assembly of a pair of gripping assemblies is oriented outward so as to engage the ramped portion of one of the opposing walls as the flexible drive means rotates around the sprockets to depress the roller and moving the gripper arm so that the second end of the gripper arm engages the optical fiber.

2. The system of claim 1, wherein the flexible drive means is a chain.

3. The system of claim 1, wherein the flexible drive means is a belt.

4. The system of claim 1, farther comprising an adjustable torque limiter disposed between the motor and the driven sprocket.

5. The system of claim 1, wherein the moveable gripping arm is biased in an open position.

6. The system of claim 5, wherein moveable gripping arm is biased by a spring.

7. The system of claim 1, further comprising a rubber pad disposed on the second end of the moveable gripper arm.

8. The system of claim 1, wherein the optical fiber is encased in a micro-tube.

9. The system of claim 8, further comprising a spherical shaped plug disposed on a distal end of the micro-tube.

10. The system of claim 8, wherein the micro-tube is wrapped around a spool before coming into engagement with the gripping assemblies, and further comprising a set of rollers for straightening the micro-tube as it is pulled from the spool before engagement with the gripping assemblies.

11. A linear traction engine for imparting motion to a metal micro-tube without imparting different velocity between the micro-tube and clamping components of the engine, comprising:
a flexible drive means rotatably mounted around a first sprocket and a second sprocket, at least one of which is driven by a motor;
a pair of opposing walls located on either side of the flexible drive means, each of the pair of opposing walls having a proximal end and a distal end, the proximal end having a ramped portion; and
a plurality of gripping assemblies mounted on the flexible drive means, each gripping assembly having a moveable gripping arm having a first end operatively connected to a roller and a second end configured to grip an optical fiber, the gripping assemblies being mounted on the flexible drive belt in pairs such that the roller of each gripping assembly of a pair of gripping assemblies is oriented outward so as to engage the ramped portion at the proximal end of one of the opposing walls as the flexible drive means rotates around the sprockets to depress the roller and moving the gripper arm so that the second end of the gripper arm engages the optical fiber when the gripping assembly is moving in a linear direction, the engagement with the optical fiber being maintained as the gripping assemblies move along the opposing walls until the gripping assembly reaches a ramp located at the end of the opposing wall, the distal ramp located such that the gripping arm of the gripping assembly disengages from the optical fiber before the movement of the gripping assembly is deflected from the linear direction by the second sprocket.

12. A method for installing an optical fiber encased in a protective sheath into a well bore, comprising:
mounting an optical fiber encased in a protective sheath in a linear traction engine;
guiding a distal end of the optical fiber encased in the protective sheath within a proximal opening of an instrument tube; and
pushing the optical fiber encased in the protective sheath into the instrument tube using the linear traction engine.

13. The method of claim 12, further comprising disposing a plug on the distal end of the optical fiber encased in the protective sheath to prevent the distal end of the optical fiber encased in the protective sheath from damage caused by internal obstructions in the instrumentation tube.

14. The method of claim 12, where in pushing the optical fiber includes:
gripping and releasing the optical fiber encased in the protective sheath with a gripping assembly so that no differential velocity is imparted between the optical fiber encased in the protective sheath and the linear traction engine; and
moving the gripping assembly in a linear direction to push the optical fiber encased in the protective sheath into the instrumentation tube.

15. The method of claim 12, wherein mounting the optical fiber encased in the protective sheath into the linear traction engine includes straightening the optical fiber encased in the protective sheath before it is mounted in the linear traction engine.

16. The method of claim 12, wherein pushing includes controlling applying a pushing force to the optical fiber encased in the protective sheath such that the applied pushing force does not exceed a safety margin determined from a compressive limit of the sheath.
